(19) United States
(12) Patent Application Publication
(10) Pub. No.: US 2023/0297542 A1
(43) Pub. Date: Sep. 21, 2023

(54) Cloud based AI Recycle Bin (AiRB)

(71) Applicant: Timothy John Ryder Shinkle, Alexandria, VA (US)

(72) Inventor: Timothy John Ryder Shinkle, Alexandria, VA (US)

(21) Appl. No.: 18/160,956

(22) Filed: Jan. 27, 2023

Related U.S. Application Data
(60) Provisional application No. 63/313,976, filed on Feb. 25, 2022.

(51) Int. Cl. G06F 16/11; G06F 16/182

(52) U.S. Cl. CPC G06F 16/125; G06F 16/1837

(57) ABSTRACT

Disclosed herein is a method for a cloud-based AI recycle bin. The method may include a step of displaying a screen that allows the user to: choose an initial setting, choose a default configuration template, choose default data processing workflows, download and install scan agents on a plurality of devices, identify and provide permissions to a plurality of storage locations, for each agent, configure target recycle bin storage location in AiRB Cloud; schedule agent(s) to scan and refresh scans as a background service with rules, and review results. The method further includes steps of copying reviewer approved results to the recycle bin prompting the reviewer to commit moves by deleting the copied source data; performing operational commands; running rule patterns and search filters on existing scans or refresh scans; configuring audits and reporting dashboards; performing auditing and reporting for oversight; and scheduling automated billing and account management.

### FIELD OF THE INVENTION

The present invention relates generally to a cloud-based AI (Artificial intelligence) recycle bin (AiRB). More specifically, the present invention is a subscription-based offering for consumers and organizations that leverages AI to effectively cleanse a customer's data automatically over time.

### BACKGROUND OF THE INVENTION

The cloud data storage market is expected to reach USD 390.33 Billion by 2028. This growth reflects organizations and consumers spending too much money storing data on premises and in the Cloud, which they no longer need and with no easy method to get rid of it. Most organizations and consumers have a significant amount of data storage savings to be realized at the right price point and level of effort. Although there are crawl technologies on the market to help cleanup data, they are expensive and designed for large organizations to run on premises, not in the Cloud, and do not leverage AI Machine Learning (ML) reinforcement learning to learn what is no longer needed or provide a recycle bin storage location. These crawl technologies are required to be installed on a server on premises or in the Cloud to process data files that involve significant manual effort to cleanse data at scale. Other inventions that provide a recycle bin are not crawl technologies and do not leverage AI ML or rule patterns to proactively search for data that is no longer needed and process the data using a workflow to clean it up over time automatically. A much simpler and more cost-effective approach to cleansing data is needed that can asynchronously, and with minimal effort, immediately start scanning a customer's storage (on premises data centers, servers, client computers and devices, cloud storage, third party social media, etc.), identifying and cleansing data that is no longer needed, continuously running in the background as a service and scaling up as needed over time.

An objective of the present invention is to provide a cost-effective and automated approach to cleansing data and storing it in a recycle bin, wherein the cleansed data can be archived, restored or permanently deleted. Accordingly, the present invention (AiRB) is a software-as-a-service (SaaS), which provides a subscription-based offering for consumers and organizations that leverages AI ML to effectively cleanse a customer's data automatically over time. To accomplish this, the present invention comprises several software components, a cloud hosted SaaS web based front end to sign up and run the service, a software backend consisting of a database (including vector search databases for indexing and storing vector embeddings of unstructured content for similarity searching), indexing engine, business and inference rules engine, AI natural language processing classifiers and ML reinforcement learning, a reporting tool, cloud-based container-orchestration platform, a storage broker, and cloud storage. Further, according to the present invention, the service includes rules that can be modified, trained or created to identify human habits of creating temporary data and labelling data as potentially no longer needed, combined with rules around data they might need to keep or delete for business compliance or other reasons.

### SUMMARY OF THE INVENTION

The present invention is a cost-effective and automated approach to cleansing data and storing it in a recycle bin, wherein the cleansed data can be archived, restored or permanently deleted. In other words, the present invention (AiRB) is a software-as-a-service (SaaS), which provides a subscription-based offering for consumers and organizations that leverages AI to effectively cleanse a customer's data automatically over time. To accomplish this, the present invention comprises several software components, a cloud hosted SaaS web based front end and account management services to sign up and run the AiRB services that include, a software backend consisting of a database including a vector search database that indexes and stores vector embeddings of unstructured content for fast retrieval and similarity searching, indexing engine, business and inference rules engine, AI natural language processing (NLP) classifiers, AI machine learning (ML) using reinforcement learning from user feedback, a reporting tool, cloud-based container-orchestration platform, a storage broker, and cloud storage. Further, according to the present invention, the service includes rules that can be modified, trained or created to identify human habits of creating temporary data and labelling data as potentially no longer needed, combined with rules around data they might need to keep or delete for business compliance reasons.

### BRIEF DESCRIPTION OF THE DRAWINGS

FIG. 1 is a block diagram representing a system overview of the present invention.

FIG. 2 is a flow diagram illustrating front-end processes or a user-end workflow of the present invention.

FIG. 3 is a flow diagram illustrating the system workflow of a method of operation, according to a preferred embodiment of the present invention.

FIG. 4 a flow diagram illustrating back-end workflow of the system according to the preferred embodiment.

FIG. 5 is a flow diagram illustrating back-end workflow of the system according to the preferred embodiment.

FIG. 6 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

While embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, and at least one network device.

Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on.

Further, one or more client devices and/or the server computer may be configured for executing a software application such as, for example, but not limited to, an operating system (e.g., Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

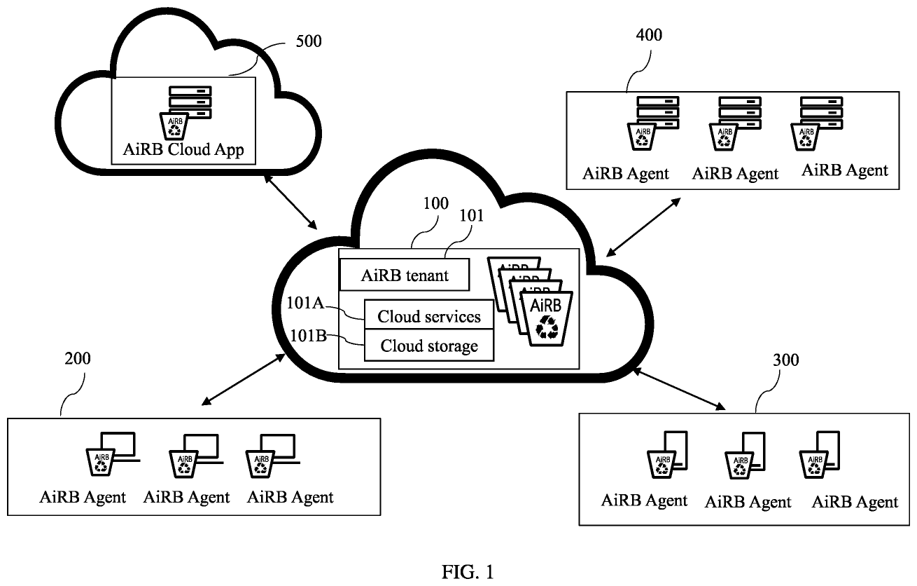

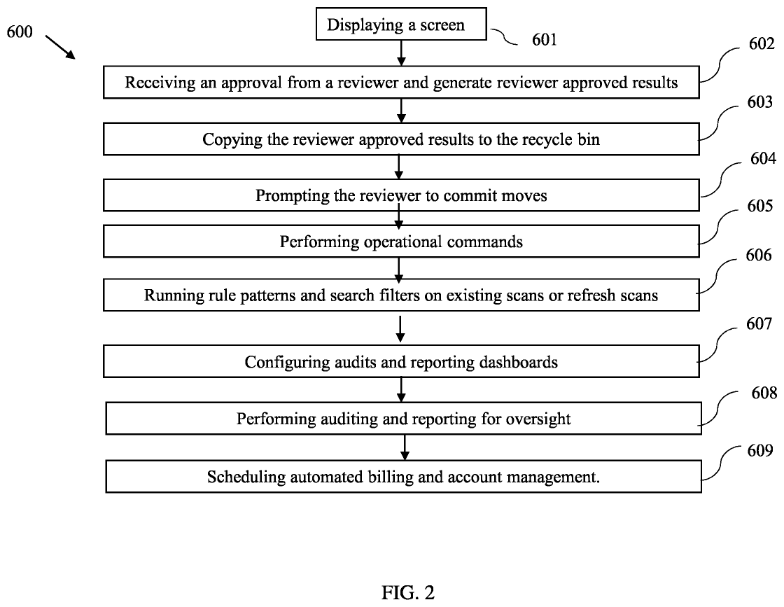

In reference to FIG. 1 through FIG. 5, the present invention is a Cloud based AI Recycle Bin (AiRB). An objective of the present invention is to provide a cost-effective and automated approach to cleansing data and storing it in a recycle bin, wherein the cleansed data can be archived, restored or permanently deleted.

Accordingly, the present invention (AiRB) is a software-as-a-service (SaaS), which provides a subscription-based offering for consumers and organizations that leverage AI to effectively cleanse a customer's data automatically over time.

To accomplish this, the present invention comprises several software components, a cloud hosted SaaS web based front end and account management services to sign up, manage and run the other services, a software backend consisting of a database (including a vector search database for indexing and storing vector embeddings of unstructured content for fast retrieval and similarity searching), indexing engine, business and inference rules engine, workflow and messaging engine, AI natural language processing (NLP) classifiers for classifying customer data, AI machine learning (ML) using reinforcement learning from user feedback to continually learn and improve on results, reporting tools, a cloud-based container-orchestration platform, a storage broker, and cloud storage. Further, according to the present invention, the service includes rules that can be modified, trained or created to identify human habits of creating temporary data and labelling data as potentially no longer needed, combined with rules around data they might need to keep or delete for business compliance reasons.

The following description is in reference to FIG. 1 through FIG. 5. In reference to FIG. 1, the present invention depicts one embodiment of the AiRB solution.

The AiRB cloud service is a multi-tenant SaaS offering that allows customers to sign up and start processing their data immediately, identifying what is no longer needed and staging in a recycle bin where it can be archived, restored or permanently deleted.

### A More Detailed Description of the Components of the Present Invention

As shown in FIG. 1, the present invention includes AI Recycle Bin (AiRB) cloud SaaS Multi-Tenant Platform 100. The AI Recycle Bin (AiRB) cloud SaaS Multi-Tenant Platform 100 is a multi-tenant cloud software-as-a-service (SaaS) platform where the AI Recycle Bin (AiRB) software services are run and maintained on computer servers in the cloud for many customers each running their own AiRB tenant 101.

The AiRB tenant 101 is an independent customer AiRB instances of AiRB cloud services 101A and AiRB recycle bin cloud storage locations (cloud storage) 101B.

The cloud services 101A is a cloud hosted SaaS web based front end and account management services to sign up, manage and run the other services, a software backend consisting of a database (including a vector search database for indexing and storing vector embeddings of unstructured content for fast retrieval and similarity search), indexing engine, business and inference rules engine, workflow and messaging engine, AI natural language processing (NLP) classifiers for classifying customer data, AI machine learning (ML) using reinforcement learning from user feedback to continually learn and improve on results, reporting tools, a cloud-based container-orchestration platform, a storage broker, and cloud storage.

The cloud storage 101B is recycle bin storage locations in the cloud for storing data that is either moved from, or, synchronized with the source storage locations that include customer computers 200, customer devices 300, customer storage network 400, and customer cloud storage 500.

The customer computers running AiRB agent 200 is an AiRB service agent that performs local client activities on the customer's computers and provides a cached recycle bin storage location that is synchronized with the AiRB cloud storage. The local agent can crawl the local computer storage, upload the results of the crawl to the AiRB cloud for analysis, notify the customer computer with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the computer is back online for exchanging data with the cloud and providing updates.

The customer devices running AirB agent 300 is an AiRB service agent that performs local client activities on the customer's devices such as smart phones and other internet devices and provides a cached recycle bin storage location that is synchronized with the AiRB cloud storage. The local agent can crawl the local devices storage, upload the results of the crawl to the AiRB cloud for analysis, notify the customer device with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the device is back online for exchanging data with the cloud and providing updates.

The customer storage network running AirB agent 400 is an AiRB service agent that performs local client activities on the customer's storage network and provides a cached recycle bin storage location that is synchronized with the AiRB cloud storage. The local agent can crawl the local storage network, upload the results of the crawl to the AiRB cloud for analysis, notify the customer's AiRB account (or via email) with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the device is back online for exchanging data with the cloud and providing updates.

The customer cloud Storage running AirB agents 500 is an AiRB service agent that performs local client activities on the customer's cloud storage and provides a cached recycle bin storage location that is synchronized with the AiRB cloud storage. The local agent can crawl the local cloud storage, upload the results of the crawl to the AiRB cloud for analysis, notify the customer's AiRB account (or via email) with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the cloud is back online for exchanging data with the AiRB cloud and providing updates.

### Additional AiRB Services Details:

Services include account management. This provides ability to sign up new accounts, manage users, roles, billing, and security such as authentication and encryption. Storage management. This provides services for monitoring and managing recycle bin storage locations across all storage locations, cloud storage, storage networks, computers, and devices. The dashboards showing results and actions taken over time, agent management showing what agent apps are installed on what devices across the organization, AI and rules management, storage management, reporting, disposition processing and other related services.

API integration services. This provides connections to third-party systems and applications to crawl and manage third-party data sources.

AiRB transportable rules and industry default classifiers (e.g., third party NLP models or pretrained classifiers and transformers). The rules can be exported and exchanged between AiRB tenants allowing for sharing rule sets between customers and defining default rule sets for different industries including rules, laws and regulations on records retention management. This includes default classifiers and third party NLP models, classifiers and transformers for different customer industries and needs that can be shared and improved over time.

AiRB Rules. The rules include the ability to analyze data based on extensions, data locations and identifiers, such as file paths and file names, content, search queries, human habits, AI for classification including NLP entity extraction, names, image searches, and OCR searches. Rules can be built-on other rules and leverage Boolean logic to build more complex rules. AI features include supervised and semi-supervised leaning for classification, as well as reinforcement learning for iterative understanding of what data needs are to the users such as being no longer needed or critically important, active, inactive, or needs to be kept indefinitely. Examples of rules include but are not limited to the following:
1. Temporary_Files can be used for files that get created by Microsoft Office and other applications for temporary purposes while running that sometimes do not get cleaned up after the application is closed.
2. Old_Sys_Gen_Backup can be used for system/application generated backup files that are at least 3 years old.
3. Zero Content can be used for files that do not contain any content and can be cleaned up for decluttering.
4. Obsolete_Install can be used for files that were used for installing an application or computer backups that are likely no longer needed.
5. Old Drafts can be used for files that have been identified as draft in the filename or path (e.g., draft, ver2, v1.0, v3, etc.) and are greater than 1 year old.
6. Human_ID_Backup can be used for files have been identified as backup or copy of in the file name or path.
7. Old_Abandoned_Apps can be used for application or configuration files that are greater than 3 years old.
8. PC_Backup can be used for files that have been identified as backup files in the filename or path (e.g., temporary internet files, my documents, downloads).
9. Human_ID_Deletable can be used for files that have been identified as deletable in the filename or path (e.g., trash, garbage, delete, remove, to be deleted, cleanup folder).
10. Human_ID_Old can be used for files that have been identified as old or superseded in the filename or path (e.g., old, outdated, superseded).
11. Old_Sys_Status_Reporting can be used for files generated by a system or application that are greater than 3 years old.
12. Other_Old_Files can be used for files older than 7 years that may not be in the other reports but may no longer be needed.
13. Large Files can be used for files that are larger than the average file (at least 12 MB in size) and represent a potential for storage space recovery and decluttering.
14. Old_Photos can be used for photos found that are over 7 years old.
15. Old_Rich_Media can be used for multi-media files found over 7 years old.
16. Compressed Duplicates can be used for files that have been compressed or zipped up and left in place with original non-compressed file.
17. Duplicates can be used for duplicate files that may no longer be needed. Note: A general rule can be requested to keep the oldest or youngest duplicate and disposed of the rest.
18. Renditions can be used for files that are renditions of other files in the same location, such as a PDF version of a MS Word document.

According to a preferred embodiment, a method of operation of the present invention comprises the following steps.

The method 600 of the present invention comprises displaying a screen 601, wherein the screen can include any electronic visual display device (e.g., a phone screen, computer monitor, including a liquid crystal display (LCD) or a light emitting diode (LED) display). Further, the screen can include any interface capable of presenting information that can be viewed by a user or a reviewer.

The screen can be configured to allow a user to: choose an initial setting, choose a default configuration template, choose default data processing workflows, download and install scan agents on a plurality of devices, identify and provide permissions to a plurality of storage locations, for each agent, configure a target recycle bin storage location in AiRB Cloud; schedule the agents to scan and refresh scans as a background service with rules, and review results. The user can review the results with search filters and suggestions for approving and moving files to the recycle bin.

The method 600 further includes steps of: receiving an approval from a reviewer and generate reviewer approved results 602; copying the reviewer approved results to the recycle bin 603; prompting the reviewer to commit moves by deleting copied source data 604; performing operational commands 605, wherein the operational commands can include Create, modify or delete commands or any other commands to operate the present invention;

running rule patterns and search filters on existing scans or refresh scans 606; configuring audits and reporting dashboards 607; performing auditing and reporting for oversight 608; and scheduling automated billing and account management 609.

In one embodiment, the initial setting may include an account type, consumer and organization. The workflows may include schedules for sending email ticklers to reviewers. The plurality of devices may include PCs and servers.

The plurality of storage locations may include local, networked, and cloud storage locations for scanning. The configuration of the target recycle bin storage location may include an option to leave links in local bin.

In some embodiments, the default configuration template may include: rules and AI classifiers for identifying files (data) for cleansing including consumer patterns for personal data files or patterns based on industry templates containing relevant document types and regulatory retention requirements for an organization's data files.

The method 600 may further includes a step of displaying a screen that allows the user to an add additional admin and reviewer accounts.

The method 600 may further include a step of displaying a screen that allows the user to choose, third party cloud-2-cloud agents for scanning and processing data in third-party clouds through API integration services.

The rules can be configured for data volume limits, refresh cycles, dates, times for stopping, restarting scans due to network traffic and sending ticklers to reviewers for reviewing and taking action on results.

The method 600 may include performing operational commands for: agents with additional data sources, rules, custom trainable AI data classifiers, default rules and search filters, scans for cleansing and training custom classifiers, and trained classifiers associated with rule patterns.

In use, the user can operate the present invention with following steps:
1. Navigate to the AI Recycle-Bin (AiRB) website at 701. (AiRB website may include a plurality of webpages design to operate the present invention and a user interface implemented as a graphical user interface (GUI) with a plurality of buttons that can be configured to interact with a user).
2. Choose an account type, consumer, or organization at 702.
3. Choose a default configuration template containing rules and AI classifiers for identifying files (data) for cleansing including consumer patterns for personal data files or patterns based on industry templates containing relevant document types and regulatory retention requirements for an organization's data files at 703.
4. Add additional admin and reviewer accounts at 704 as needed.
5. Choose default data processing workflows with schedules for sending email ticklers to reviewers at 705.
6. Download and install scan agents on devices, PCs and servers (Windows, macOS, Linux, Unix, iOS, Android, Cloud VMs) at 706.
7. Choose third party cloud-2-cloud agents for scanning and processing data in third-party clouds (e.g., Facebook data) at 707.
8. For each agent, identify and provide permissions to local, networked, and Cloud storage location(s) for scanning at 708.
9. Configure target recycle bin storage location in AiRB Cloud with option to leave links in local bin as feasible at 709.
10. Schedule agent(s) to scan and refresh scans as a background service with rules for data volume limits, refresh cycles, dates, and times for stopping and restarting scans due to network traffic and sending ticklers to reviewers for reviewing and taking action on results at 710.

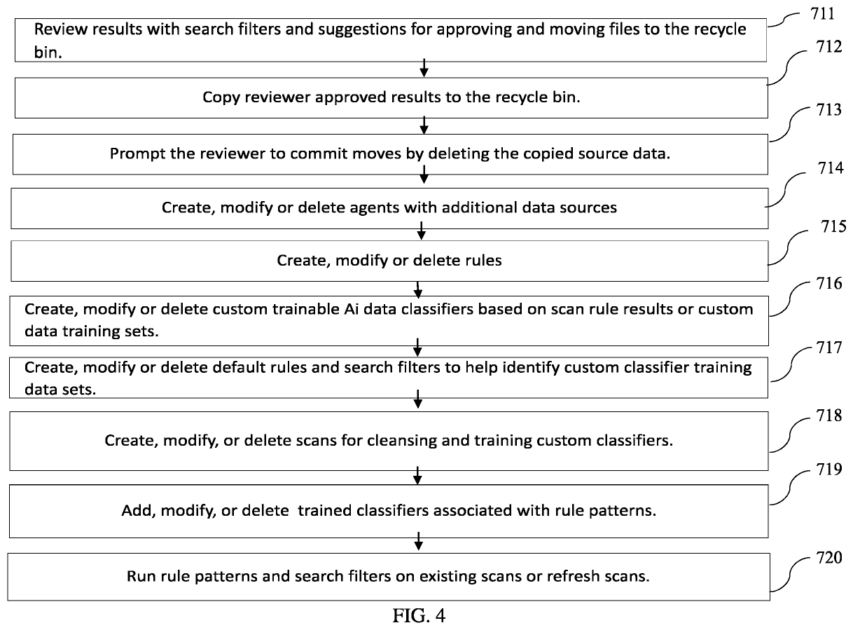

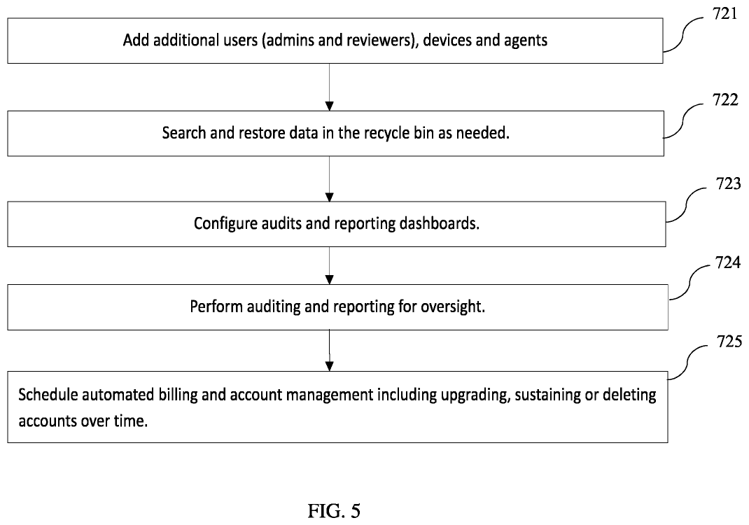

As shown in FIG. 4 (back-end workflow of the system), the steps continue as follows:
11. Review results with search filters and suggestions for approving and moving files to the recycle bin at 711 (This step informs the AI reinforcement learning algorithm in the process where the system learns from user feedback and provides an option to auto-update the rules and results with learned patterns from the reviewed results and improve rule accuracy over time, this includes auto-adjusting the classifier training sets for retraining the classifiers with more accurate representative data sets).
12. Copy reviewer approved results to the recycle bin at 712.
13. Prompt the reviewer to commit moves by deleting the copied source data at 713.
14. Create, modify, or delete agents with additional data sources at 714.
15. Create, modify, or delete rules at 715.
16. Create, modify, or delete custom trainable AI data classifiers based on scan rule results or custom data training sets at 716.
17. Create, modify, or delete default rules and search filters to help identify custom classifier training data sets at 717.
18. Create, modify, or delete scans for cleansing and training custom classifiers at 718.
19. Add, modify, or delete trained classifiers associated with rule patterns at 719.
20. Run rule patterns and search filters on existing scans or refresh scans at 720.
As shown in FIG. 5 (back-end workflow of the system), the steps may continue as follows:
21. Add additional users (admins and reviewers), devices and agents at 721.
22. Search and restore data in the recycle bin as needed. at 722.
23. Configure audits and reporting dashboards at 723.
24. Perform auditing and reporting for oversight at 724.
25. Schedule automated billing and account management including upgrading, sustaining or deleting accounts over time at 725.

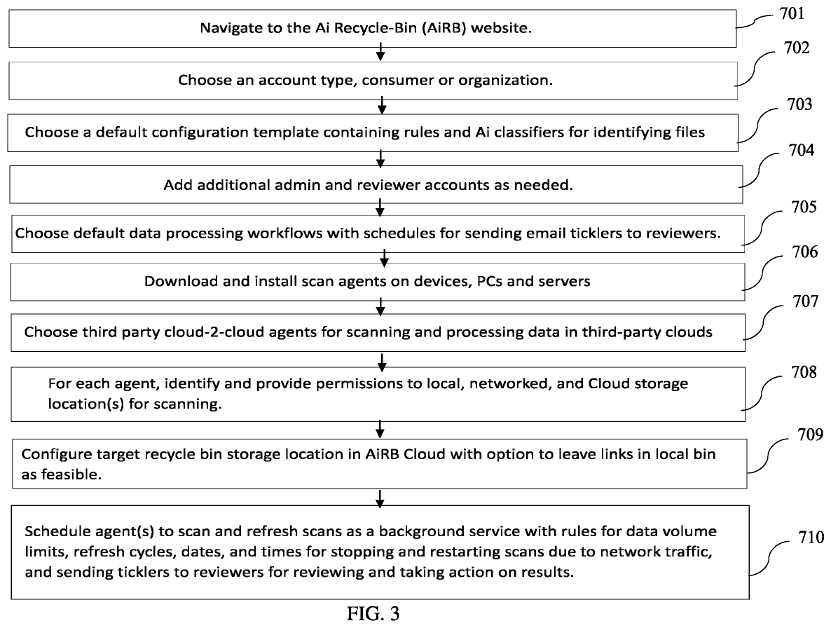

As seen in FIG. 3, and as shown in steps 701 through 710, a set of front-end processes or user-end steps involve choosing an account type, consumer or organization. In other words, the present invention enables users to select a plan according to their needs and budget. Accordingly, the present invention may scale up the package and requirements for bigger corporations as well as scale down for individuals.

In reference to FIG. 4 and as shown in steps 711 through 720, the present invention allows users to create, modify, or delete rules, agents, AI data classifiers etc. at any point of time. This will enable the program to learn and get customized according to the user's needs with time.

As seen in FIG. 5 as shown in steps 721 through 725, the user can further add agents, search, and restore data from the recycle bin, perform auditing, and make changes to the account. All these features make the present invention customizable, efficient, and user-friendly.

According to the present invention, in some embodiments, the components can be put together in a backend software platform with server components and services running in cloud-based containers hosted by a cloud vendor platform. A cloud web front end running in a browser is provided to perform customer interaction, service usage, reporting, and administration. The rules are transportable in a native rule engine language and can be uploaded and stored in the backed database. The rules can be considered add-ons and shared across customers. Reports can also be exported, shared, marked up in spreadsheet or CSV format and imported back into the cloud service for processing. The AI classifiers can be unique to each customer or shared as based on anonymous cleansing of customer data and customer approval for training the classifiers on generic data types found across different customers. The front end provides sign up and account management, a user-interface (UI) to administer the service and a UI for reviewing and processing the results. Each customer will have their own instance of the services for their personal or business use.

The recycle bin storage is cloud-based storage negotiated with cloud vendors for cost-effective long-term storage of inactive data. Customers will pay for both processing data and for storing data in the recycle bin. The recycle bin can be exposed as an agent running on the operating system of the customers computer device or devices. Customers who cancel their service can download their recycle bin data or move it to another cloud vendor prior to cancelation.

Thus, the present invention provides and easy and user-friendly space saving solution, wherein customers get to sign up and start processing their data immediately, identifying what is no longer needed and staging in a recycle bin where it can be archived, restored, or permanently deleted.

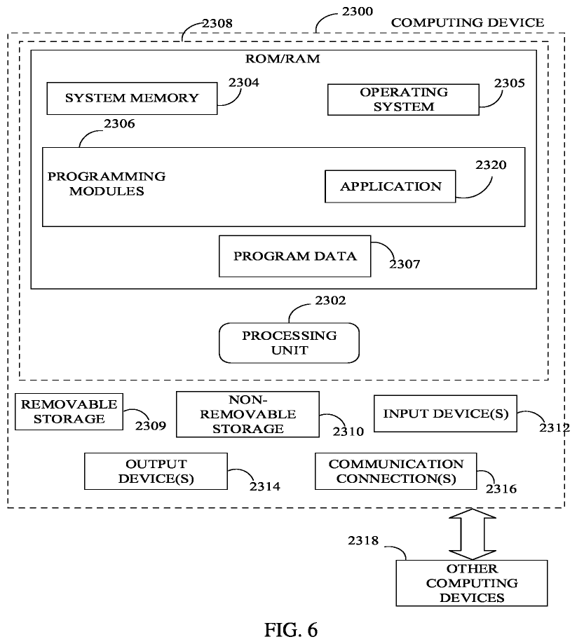

With reference to FIG. 6, a system consistent with an embodiment of the disclosure may include a computing device or cloud service, such as computing device 2300. In a basic configuration, computing device 2300 may include at least one processing unit 2302 and a system memory 2304. Depending on the configuration and type of computing device, system memory 2304 may comprise, but is not limited to, volatile (e.g., random-access memory (RAM)), non-volatile (e.g., read-only memory (ROM)), flash memory, or any combination. System memory 2304 may include operating system 2305, one or more programming modules 2306, and may include a program data 2307. Operating system 2305, for example, may be suitable for controlling computing device 2300's operation. In one embodiment, programming modules 2306 may include image-processing module, machine learning module. Furthermore, embodiments of the disclosure may be practiced in conjunction with a graphics library, other operating systems, or any other application program and is not limited to any particular application or system. This basic configuration is illustrated in FIG. 6 by those components within a dashed line 2308.

Computing device 2300 may have additional features or functionality. For example, computing device 2300 may also include additional data storage devices (removable and/or non-removable) such as, for example, magnetic disks, optical disks, or tape. Such additional storage is illustrated in FIG. 6 by a removable storage 2309 and a non-removable storage 2310. Computer storage media may include volatile and non-volatile, removable and non-removable media implemented in any method or technology for storage of information, such as computer-readable instructions, data structures, program modules, or other data. System memory 2304, removable storage 2309, and non-removable storage 2310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 2300. Any such computer storage media may be part of device 2300. Computing device 2300 may also have input device(s) 2312 such as a keyboard, a mouse, a pen, a sound input device, a touch input device, a location sensor, a camera, a biometric sensor, etc. Output device(s) 2314 such as a display, speakers, a printer, etc. may also be included. The aforementioned devices are examples and others may be used.

Computing device 2300 may also contain a communication connection 2316 that may allow device 2300 to communicate with other computing devices 2318, such as over a network in a distributed computing environment, for example, an intranet or the Internet. Communication connection 2316 is one example of communication media. Communication media may typically be embodied by computer readable instructions, data structures, program modules, or other data in a modulated data signal, such as a carrier wave or other transport mechanism, and includes any information delivery media.

The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2304, including operating system 2305. While executing on processing unit 2302, programming modules 2306 (e.g., application 2320 such as a media player) may perform processes including, for example, one or more stages of methods, algorithms, systems, applications, servers, databases as described above. The aforementioned process is an example, and processing unit 2302 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged, or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart.

For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

The following is claimed:

1. A method comprising
displaying a screen that allows a user to:
choose an initial setting,
choose a default configuration template,
choose default data processing workflows,
download and install scan agents on a plurality of devices,
identify and provide permissions to a plurality of storage locations, for each agent,
configure a target recycle bin storage location in AiRB Cloud;
schedule the agents to scan and refresh scans as a background service with rules, and
review results;
receiving an approval from a reviewer and generate reviewer approved results;
copying the reviewer approved results to the recycle bin;
prompting the reviewer to commit moves by deleting copied source data;
performing operational commands;
running rule patterns and search filters on existing scans or refresh scans;
configuring audits and reporting dashboards;
performing auditing and reporting for oversight; and
scheduling automated billing and account management.

2. The method as claimed in claim 1, wherein the initial setting includes an account type, consumer and organization.

3. The method as claimed in claim 1, wherein the workflows includes schedules for sending email ticklers to reviewers.

4. The method as claimed in claim 1, wherein a plurality of devices includes PCs and servers.

5. The method as claimed in claim 1, wherein a plurality of storage locations includes local, networked, and cloud storage locations for scanning.

6. The method as claimed in claim 1, wherein the configuration of the target recycle bin storage location includes an option to leave links in local bin.

7. The method as claimed in claim 1, wherein the default configuration includes:
rules and AI classifiers for identifying files.

8. The method as claimed in claim 1, wherein the method further includes a step of displaying a screen that allows the user to an add additional admin and reviewer accounts.

9. The method as claimed in claim 1, wherein the method further includes a step of displaying a screen that allows the user to choose, third party cloud-2-cloud agents for scanning and processing data in third-party clouds through API integration services.

10. The method as claimed in claim 1, wherein the rules are configured for data volume limits, refresh cycles, dates, times for stopping, restarting scans due to network traffic, sending ticklers to the reviewers for reviewing and taking action on the results.

11. The method as claimed in claim 1, wherein the results include search filters and suggestions for approving and moving files to the recycle bin.

12. The method as claimed in claim 1, wherein performing operational commands for:
agents with additional data sources,
rules,
custom trainable AI data classifiers,
default rules and search filters,
scans for cleansing and training custom classifiers, and
trained classifiers associated with rule patterns.

13. A method comprising
displaying a screen that allows a user to:
choose an initial setting,
choose a default configuration template,
choose default data processing workflows, wherein the workflows includes schedules for sending email ticklers to reviewers.
download and install scan agents on a plurality of devices,
identify and provide permissions to a plurality of storage locations, for
each agent, wherein the plurality of storage locations include,
local, networked, and cloud storage locations for scanning,
configure target recycle bin storage location in AiRB Cloud;
schedule agents to scan and refresh scans as a background service with rules, and
review results;
receiving an approval from the reviewer and generate reviewer approved results;
copying reviewer approved results to the recycle bin;
prompting the reviewer to commit moves by deleting copied source data;
performing operational commands;
running rule patterns and search filters on existing scans or refresh scans;
configuring audits and reporting dashboards;
performing auditing and reporting for oversight; and
scheduling automated billing and account management.

14. The method as claimed in claim 13, wherein the default configuration includes:
rules and AI classifiers.

15. The method as claimed in claim 13, wherein the method includes performing operational commands for:
agents with additional data sources,
rules,
custom trainable AI data classifiers,
default rules and search filters
scans for cleansing and training custom classifiers, and
trained classifiers associated with rule patterns.

16. The method as claimed in claim 13, wherein the method further includes a step of displaying a screen that allows the user to choose, third party cloud-2-cloud agents for scanning and processing data in third-party clouds through API integration services.

17. A non-transitory computer readable medium that stores instructions to be executed by a computerized system for:
displaying a screen that allows a user to:
choose an initial setting,
choose a default configuration template,
choose default data processing workflows,
download and install scan agents on a plurality of devices,
identify and provide permissions to a plurality of storage locations, for each agent,
configure a target recycle bin storage location in AiRB Cloud;
schedule agents to scan and refresh scans as a background service with rules, and
review results;
receiving an approval from a reviewer and generate reviewer approved results;
copying the reviewer approved results to the recycle bin;
prompting the reviewer to commit moves by deleting the copied source data;
performing operational commands;
running rule patterns and search filters on existing scans or refresh scans;
configuring audits and reporting dashboards;
performing auditing and reporting for oversight; and
scheduling automated billing and account management.

18. The non-transitory computer readable medium as claimed in claim 17, wherein the non-transitory computer readable medium further stores instructions to be executed by a computerized system for performing operational commands for:
agents with additional data sources,
rules,
custom trainable AI data classifiers based on scan rule results or custom data training sets,
default rules and search filters to help identify custom classifier training data sets,
scans for cleansing and training custom classifiers, and
trained classifiers associated with rule patterns.

19. The non-transitory computer readable medium as claimed in claim 17, wherein the default configuration template includes rules and AI classifiers.

20. The non-transitory computer readable medium as claimed in claim 17, wherein the non-transitory computer readable medium further stores instructions to be executed by a computerized system for performing operational commands for: displaying a screen that allows the user to choose, third party cloud-2-cloud agents for scanning and processing data in third-party clouds through API integration services.
